(19) United States
(12) Patent Application Publication
(10) Pub. No.: US 2020/0274427 A1
(43) Pub. Date: Aug. 27, 2020

(54) METHOD FOR PRODUCING INSULATED WINDING ELEMENTS

(71) Applicant: VOITH PATENT GMBH, HEIDENHEIM (DE)

(72) Inventors: MARCELO JACOB DA SILVA, SAO PAULO (BR); CAMILA GONCALVES DOS SANTOS, SAO PAULO (BR); TAMY KOREEDA AOKI, SAO PAULO (BR); FERNANDO PEREIRA, SAO PAULO (BR); TOMAS ERIKSON LAMAS, JUNDIAI (BR); EGIDIO JOSE FARIA, SAO PAULO (BR); THOMAS HILDINGER, SANTANA (BR); JOAO FIORINO CORDEIRO, CAMPO LIMPO PAULISTA - SP (BR)

(21) Appl. No.: 16/641,367

(22) PCT Filed: Aug. 16, 2018
(86) PCT No.: PCT/EP2018/072180

§ 371 Date: May 8, 2020

(30) Foreign Application Priority Data
Aug. 23, 2017 (DE) 10 2017 119 248.4

(51) Int. Cl. H02K 15/12; H02K 15/10; B29C 43/18; B29C 33/58; B29C 33/62

(52) U.S. Cl. CPC H02K 15/12; H02K 15/105; B29L 2031/34; B29C 33/58; B29C 33/62; B29C 43/18

(57) ABSTRACT

A method for producing insulated winding elements for an electric machine includes steps V1 to V6, as follows: V1—providing a line element; V2—applying an insulation; V3—impregnating the insulation with resin; V4—inserting the insulated winding element into a press mold (1) and pressing; V5—curing the impregnation; V6—removing the winding element from the press mold (1) and cleaning the press mold (1). The base body (10) of the press mold (1) is formed of metal, and the surfaces of the press mold (1) that come into contact with resin during the process have a coating. The coating has two sublayers (11, 12). A first sublayer (11) is in direct contact with the base body (10) and is formed as a priming coat. A second sublayer (12) is in direct contact with the priming coat (11) and is formed as an anti-adhesion layer of fluorinated polyurethane.

The present invention relates to a process for producing insulated winding elements for an electrical machine, especially the forming of the insulation.

The insulated winding elements of large electrical machines are present in grooves in the laminated core of the electrical machine. In order to assure a very good fit of the insulated winding elements in the grooves, the insulation of the winding elements has to have a corresponding outline. The outline of the insulation is generated during the production process in that a conductive element with insulation wound around it is compressed in a mold. In order to bond the layers of the winding to one another and to assure a permanent outline, the insulation material is impregnated with resins that solidify on curing to form a homogeneous structure. The impregnation with the resins here may precede or follow the insertion of the wrapped conductive element into the compression mold. In each case, the resin is cured while the conductive element is in the compression mold. The winding elements may be single conductor bars or whole coils. Such production processes are known from the prior art. In this regard, reference is made by way of example to CH 182810, CH 345687 and WO 2016/173608 A1.

In the known production process, the compression molds used come into direct contact with the resin. It is therefore inevitable that some of the resin will adhere to the molds. Before the molds are used again, they therefore have to be cleaned in a complex manner, which is firstly time-consuming and secondly entails the use of solvents that are not unproblematic in terms of environmental compatibility.

The inventors have set themselves the task of improving the known operation such that the time for the cleaning of the compression molds is reduced, and fewer or more environmentally compatible cleaning compositions are required.

The inventors have recognized that the stated object is achievable by a process having the features of claim 1. Advantageous embodiments are apparent from the subsidiary claims dependent on claim 1.

The solution of the invention is elucidated in detail by figures. Specifically, the figures show the following:

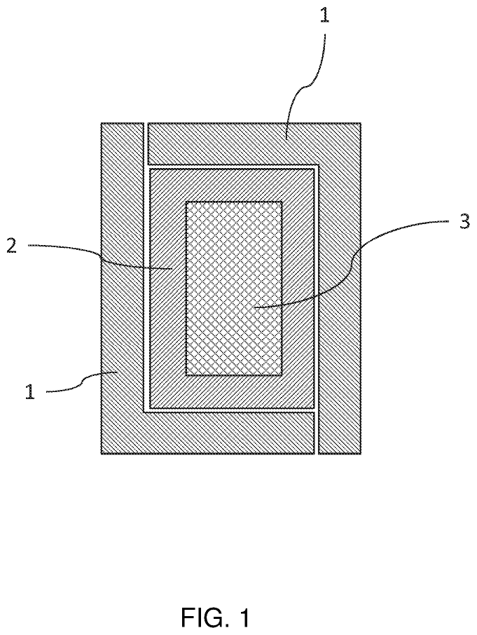

FIG. 1 insulated winding bar in compression mold;

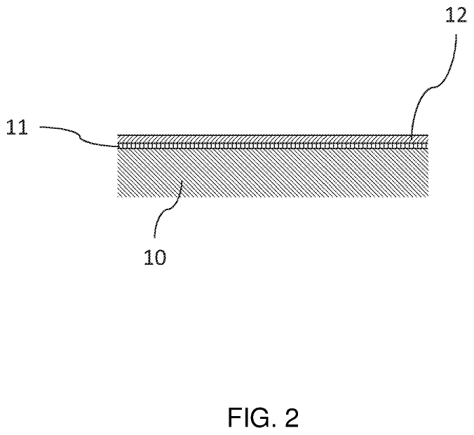

FIG. 2 construction of a compression mold for the process of the invention;

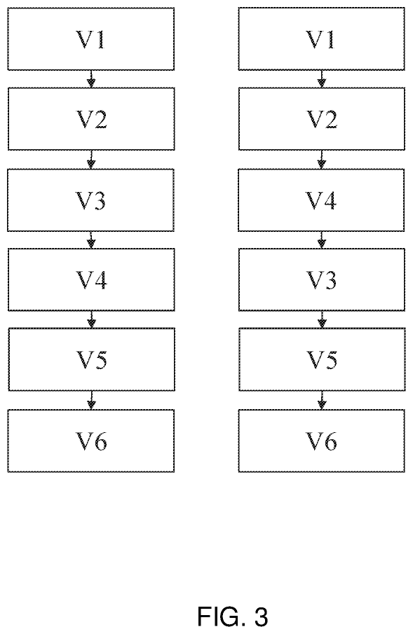

FIG. 3 flow diagram of the process of the invention in two embodiments.

FIG. 1 shows a schematic diagram of a section through an insulated winding bar in a compression mold. The compression mold consists of two sub-molds of L-shaped cross section, labeled 1. Between the two sub-molds 1 is an insulated winding bar, with the insulation labeled 2 and the conductor bar 3. By pressing the sub-molds 1 together, the insulation 2 of the winding bar takes on a rectangular outline, such that the winding bar fits into the groove provided in the laminated core. It should be noted that the process of the invention is not limited to compression molds of L-shaped cross section, but is executable with all conceivable geometries of compression molds.

FIG. 2 shows a schematic diagram of the construction of a compression mold for use in the process of the invention. The compression mold comprises a metallic main body labeled 10. The main body usually consists of steel or copper, although other standard metals may also be used. The surfaces of the compression mold that come into contact with impregnation resin in the execution of the process of the invention have been provided with a coating comprising two sublayers. The first layer in direct contact with the main body 10 is a primer labeled 11. The second sublayer that comes into direct contact with the primer 11 is an anti-adhesion layer labeled 12. The anti-adhesion layer comprises fluorinated polymers. It is possible in principle to use all known fluorinated polymers. One example is fluorinated polyurethane, which is notable for ease of usability. Fluorinated polyurethane adheres to many conventional primers. For other fluorinated polymers, it is generally necessary to use specific primers developed for the respective fluorinated polymer. A thickness of 40 to 150 micrometers for the system composed of primer 11 and anti-adhesion layer 12 has been found to be particularly advantageous.

The use of an anti-adhesion layer considerably lowers the adhesion of the impregnation resin to the surface of the compression mold. As a result, the compression molds can be cleaned very much more easily after use, which resulted in a time saving of up to 80%. The material expenditure was reduced to cleaning cloths and mild solvents, which distinctly increased the sustainability of the process. Moreover, the anti-adhesion layer also has an advantageous effect on the removal of the insulated winding element from the compression mold since the winding element can be more easily parted from the mold.

FIG. 3 shows the flow diagrams of the production process of the invention in two different embodiments. The individual process steps are designated V1 to V6. The process steps comprise the following actions:

V1: providing a conductor element

V2: applying insulation to the conductor element

V3: impregnating the insulation with resin

V4: placing the insulated winding element into a compression mold and compressing

V5: curing the impregnation

V6: removing the winding element from the compression mold and cleaning the compression mold

The two embodiments differ merely in that, in the first embodiment, step V3 is executed prior to step V4, with the reverse sequence of the two steps in the second embodiment.

It should also be noted that there are also insulation materials that have already been impregnated with resin. It is clear that, in that case, step V3 has already been effected by the provision of such an insulation material.

1-7. (canceled)

8. A method of producing insulated winding elements for an electrical machine, the method comprising:
providing a conductor element (V1);
applying insulation to the conductor element (V2);
impregnating the insulation with resin (V3) to form an insulated winding element;
providing a compression mold (1), placing the insulated winding element into a compression mold (1), and compressing (V4) the insulated winding element;
curing the impregnation (V5); and
removing the winding element from the compression mold (1) and cleaning the compression mold (1) (V6);
the compression mold (1) having a main body (10) of metal, and surfaces of the compression mold (1) that come into contact with the resin during the placing and curing steps being provided with a coating formed of two sublayers (11, 12), the sublayers including a first sublayer (11) being a primer in direct contact with the main body (10) and a second sublayer (12) in direct contact with the primer (11), the second sublayer (12) being an anti-adhesion layer formed with fluorinated polyurethanes.

9. The process according to claim 8, which comprises executing the impregnating step (V3) before the placing step (V4).

10. The process according to claim 8, which comprises executing the impregnating step (V3) after the placing step (V4).

11. The process according to claim 8, wherein a thickness of the coating is between 40 and 150 micrometers.

12. The process according to claim 8, wherein the conductor element is a single conductor bar.

13. The process according to claim 8, wherein the conductor element is a coil.
